(19) United States
(12) Patent Application Publication
(10) Pub. No.: US 2025/0377516 A1
(43) Pub. Date: Dec. 11, 2025

(54) LOOSELY BUNDLED SUBUNITS AND METHODS OF MANUFACTURING SAME

(71) Applicant: CORNING RESEARCH & DEVELOPMENT CORPORATION, Corning, NY (US)

(72) Inventors: William Carl Hurley, Hickory, NC (US); Peter Stuart Niehoff, Connelly Springs, NC (US); Rebecca Elizabeth Sistare, Hickory, NC (US)

(21) Appl. No.: 19/310,035

(22) Filed: Aug. 26, 2025

Related U.S. Application Data
(63) Continuation of application No. PCT/US2024/017787, filed on Feb. 29, 2024.
(60) Provisional application No. 63/450,269, filed on Mar. 6, 2023.
(60) Provisional application No. 63/546,549, filed on Oct. 31, 2023.

(51) Int. Cl. G02B 6/44

(52) U.S. Cl. CPC G02B 6/4479

(57) ABSTRACT

Provided are embodiments of an optical fiber cable. The optical fiber cable includes a plurality of optical fibers, a plurality of subunits, each subunit having a subunit binder surrounding the plurality of optical fibers, and a cable jacket surrounding the plurality of subunits. The subunit binders of the subunits loosely contain their respective optical fibers.

### PRIORITY APPLICATION

This application is a continuation of International Patent Application No. PCT/US2024/017787, filed on Feb. 29, 2024, which claims the benefit of priority of U.S. Provisional Application No. 63/450,269, filed on Mar. 6, 2023, and U.S. Provisional Application No. 63/546,549, filed on Oct. 31, 2023, the content of which is relied upon and incorporated herein by reference in its entirety.

### BACKGROUND OF THE DISCLOSURE

The present disclosure generally relates to optical fiber cables having a high density of optical fibers in a reduced diameter jacket, and methods relating to manufacturing the same. Previous cable designs utilized conventional ribbons in stacks stranded together with a subunit binder to achieve high fiber density. With advancements in the manufacturing process for rollable or flexible ribbons, and the use of smaller diameter fibers, even higher fiber densities can be achieved. Rollable ribbons allow for more effective packaging than conventional ribbons inside the cable diameter, however they still require free space to allow the ribbons and fibers to move to low stress positions during cable bending and twisting. While elimination of free space to reduce diameter is a design goal for most high-density cables, bundling the fibers and ribbons in ways to provide the correct range of free space needed for fiber movement, while also allowing the bundles to conform to the shape needed to utilize as much of free space available within the cable jacket inner diameter (ID), is a delicate balancing act. Properly balanced, high fiber count cables with flexible ribbons are possible that permit organization for ease of installation and connectorization while allowing just enough free space to permit handling and manufacturing into a cable that will meet attenuation specifications even when subjected to blowing the cable through ducts.

### SUMMARY OF THE DISCLOSURE

In one aspect, embodiments of the present disclosure relate to an optical fiber cable. The optical fiber cable includes a cable jacket having an inner surface and an outer surface. The inner surface defines a central cable bore, and the outer surface defines an outermost surface of the optical fiber cable. The optical fiber cable also includes a cable core disposed in the central cable bore. The cable core has a cross-sectional area and a plurality of optical fibers provided in the core, each of the plurality of optical fibers having an outer diameter of less than or equal to 250 microns, or less than or equal to 210 microns.

In still a further aspect, embodiments of the present disclosure relate to an optical fiber cable. The optical fiber cable includes a cable jacket having an inner surface and an outer surface in which the inner surface defines a central cable bore extending along a longitudinal axis of the optical fiber cable and in which the outer surface defines an outermost surface of the optical fiber cable. The optical fiber cable also includes a plurality of subunits disposed within the central cable bore. Each subunit of the plurality of subunits includes at least two optical fibers surrounded by a subunit binder. In exemplary embodiments, the subunit binder comprises a thin film having a thickness of 40-60 microns and the subunit binder is reconfigurable between a plurality of shapes, and the plurality of shapes is defined by a perimeter of the subunit binder as viewed from a cross-section of the subunit 24 taken perpendicular to the longitudinal axis.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 depicts a cross-sectional view of a high-density optical fiber cable, according to an exemplary embodiment.

FIG. 2 is a flow diagram illustrating an exemplary method for forming an optical fiber cable having loosely-bundled subunits.

FIG. 3 is a flow diagram illustrating an exemplary method for forming a loosely-bundled subunit.

FIG. 4A depicts an exemplary system for forming a loosely-bundled subunit.

FIG. 4B depicts an exemplary lay plate.

FIG. 5A is a cross-sectional view of the system of FIG. 4A.

FIG. 5B is another cross-sectional view of the system of FIG. 4A.

FIG. 6 depicts another exemplary system for forming a loosely-bundled subunit.

FIG. 7A is a cross-sectional view of the system of FIG. 6 in various embodiments.

FIG. 7B is another cross-sectional view of the system of FIG. 6.

FIG. 8 depicts still another exemplary system for forming a loosely-bundled subunit.

FIG. 9A is a cross-sectional view of the system of FIG. 8.

FIG. 9B is another cross-sectional view of the system of FIG. 8.

FIG. 10 depicts a perspective view of an exemplary guide system for use in forming loosely-bundled subunits.

### DETAILED DESCRIPTION

Various technologies pertaining to a high-density optical fiber cable and methods for manufacturing the same are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices may be shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something, and is not intended to indicate a preference.

Embodiments of the present disclosure relate to a high-density optical fiber cable. In one or more embodiments, the optical fibers are provided in reconfigurable subunits having a thin subunit binder so that the subunits can be tightly packed within the cable core. Advantageously, an optical fiber cable having these characteristics combines a high fiber density with a small diameter and the requisite properties for jetting the cable through ducts. In various embodiments, the subunit binder can be formed such that the subunit binder has a diameter that is greater than a diameter of a bundle of optical fibers disposed therein, such that the subunit binder is “loose” around the bundle of optical fibers. Such embodiments can provide lower fiber signal attenuation and greater fiber density within the optical fiber cable than embodiments having subunit binders that are tightly formed around bundles of optical fibers.

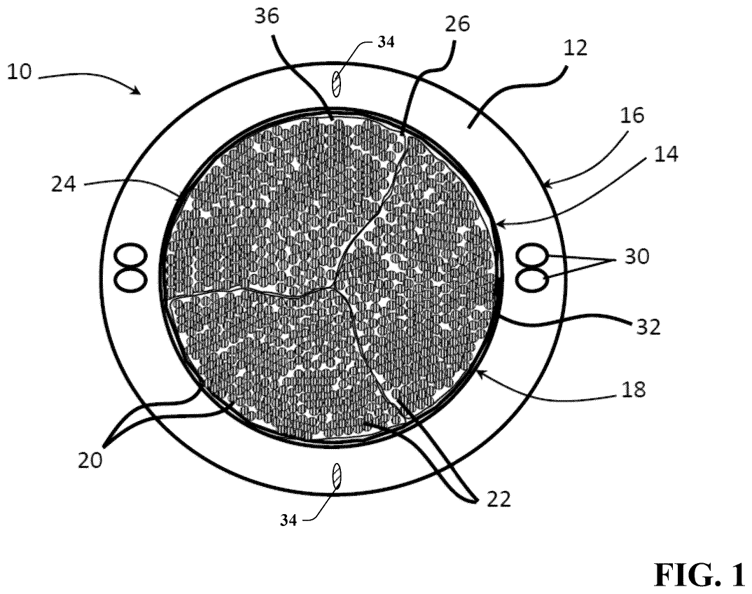

FIG. 1 depicts a cross-sectional view of an example embodiment of a high-density optical fiber cable 10 according to the present disclosure. The optical fiber cable 10 includes a cable jacket 12 having an inner surface 14 and an outer surface 16. The inner surface 14 of the optical fiber cable 10 defines a central core 18 that extends along a longitudinal axis of the optical fiber cable 10. Disposed within the central core 18 of the optical fiber cable 10 is a plurality of optical fibers 20. The plurality of optical fibers 20 can be in the form of optical fiber ribbons 22 that include optical fibers 20 joined intermittently to increase the flexibility of the ribbons 22 in bending, allowing the ribbons 22 to roll, fold, collapse, or otherwise transition from a planar configuration to a non-planar configuration. Advantageously, the non-planar configuration of the optical fiber ribbons 22 permits the optical fiber ribbons 22 to be more densely packed into the cable core 18. In contrast, conventional optical fiber ribbons that are held rigidly in the planar configuration require a greater amount of free space within the cable core to accommodate the ribbon stack without creating stress on the edge fibers.

The plurality of optical fiber ribbons 22 are arranged in a plurality of subunits 24, with each subunit 24 comprising a respective subset of the plurality of optical fiber ribbons 22 being surrounded by a subunit binder 26. The subunit binder 26 is a thin and flexible sheath that allows for the subunits 24 to be reconfigured into a variety of different shapes. In the particular embodiment depicted in FIG. 1, each subunit contains a total of 288 fibers arranged in flexible optical fiber ribbons 22 for a total count of 864 fibers in the central bore 18 of the cable 10. In this way, the subunits 24 can be densely packed within the cable core 18 by changing shape, e.g., flattening out, bunching up, or bending, as necessary to fill space within the cable core 20. It is to be understood that a number of the optical fibers 20 in each of the subunits 24 can be other than 288. In a non-limiting example, each of the ribbons 22 can include 12 of the optical fibers 20, and a number of the optical fibers 20 in each of the subunits 24 can be 12, 24, 48, 96, 144, or other multiple of 12. Still further, while FIG. 1 depicts a plurality of three subunits 24, a number of the subunits 24 can be substantially any number depending on a desired number of optical fibers 20 in the cable 10 and a number of optical fibers 20 or optical fiber ribbons 22 desirably included in each of the subunits 24.

Ribbon orientation in the subunits 24 can be helically stranded, SZ stranded, shuffled (slightly SZ stranded), or longitudinal. Helical stranding provides continuous stranding but may not be needed for all applications. Longitudinal ribbons provide advantages for manufacturing including a smaller capital investment up front for a manufacturing line and higher potential line speeds due to non-rotating equipment.

In one or more embodiments, the subunit binder 26 is a thin film jacket that surrounds a plurality of the ribbons 22 such that the jacket is continuous peripherally when viewed in cross-section along an entire length of the subunit 24. In other words, the thin film jacket is a continuous sheath that, absent unintentional damage, is a flexible tube defined by a single, continuous exterior surface; a single, continuous interior surface that defines an interior region of the subunit 24; and two openings disposed at opposite ends of the length of the thin film jacket. In exemplary embodiments, the thin film subunit binder 26 has a wall thickness of less than or equal to 150 microns (μm). In further exemplary embodiments, the thin film subunit binder 26 has a wall thickness of less than or equal to 100 microns. In yet further embodiments, the thin film subunit binder 26 has a wall thickness of less than or equal to 50 microns. In still further embodiments, the thin film subunit binder 26 can have a wall thickness between 30 microns and 100 microns, and in some embodiments more particularly between 40 and 60 microns, and in some embodiments still more particularly between 45 and 55 microns. In various embodiments, the thin film subunit binder 26 comprises a linear low-density polyethylene (LLDPE) material. In some embodiments, the thin film subunit binder 26 comprises a low-density polyethylene (LDPE). In still further embodiments, the thin film subunit binder 26 comprises a low-smoke zero-halogen (LSZH) material. In yet further embodiments, the thin film subunit binder 26 comprises polyvinyl chloride (PVC).

Ease of access to the fibers or ribbons within the subunit 24 is desirable. Various materials from which the thin film subunit binder 26 is formed may have relatively high elongation to break which can hinder access to the ribbons 22. In accordance with aspects of the present disclosure, a thin film subunit binder 26 can further include inorganic fillers that reduce the tear strength of the thin film material while maintaining sufficient elongation to break to allow the thin film subunit binder 26 to be readily manufactured and incorporated as a component of an optical fiber cable. In exemplary embodiments, the inorganic fillers may include talc, kaolin, fire retardants or other suitable materials. Fire retardant fillers perform the double function of improving fiber access while assisting the cable to achieve a required burn rating such as those listed in NFPA 262, UL-1666 or EN 50399.

Free space within each subunit 24 allows the ribbons 22 to move to low stress positions within the bundle and the cable during manufacture and handling. As used herein, the free space within a subunit 24 refers to that portion of the cross-sectional area of the interior of the subunit 24, looking along the length of the subunit 24, that is not occupied by optical fibers or other cable elements (e.g., yarns, tapes, powders, strength elements, etc.) when the subunit binder 26 is expanded to its greatest diameter. A formal definition of free space follows below in Eq. 2. However, greater free space contributes to a larger subunit outside diameter (OD) and perimeter in a typical round configuration of the subunit 24. In high density, high fiber count cables, in order to utilize all the free space within the inner diameter (ID) of the cable jacket 12, the subunits 24 are desirably able to conform to different shapes depending on their location within the cable core 18. A larger subunit perimeter enables a wider range of shapes to which the subunit can conform to use the free space within the cable jacket 12. The wall thickness of a thin film subunit binder 26 also affects the ability of the subunit 24 to conform to certain shapes. All else being equal, a thicker wall of a thin film subunit binder 26 decreases the ability of the subunit 24 to conform to certain shapes and reduces the free space available within the ID of the cable jacket 12. The loose subunits 24 of the present disclosure allow the subunits 24 to conform to the desired shapes and consume less space than thick-walled prior art buffer tubes. However, the larger perimeter of the subunit binder 26 relative to a tightly-bound subunit uses more material and therefore more space within the cable. Additionally, if the perimeter of the subunit 24 is too large, the subunit binder 26 can fold over itself as the bundle conforms to a shape within the cable.

The subunits 24 described herein can be combined into any combination of cable designs with two or more subunits with two or more fibers/ribbons per subunit, such as, but not limited to, a three-subunit layer cable with twelve subunits around nine subunits around a center core of three subunits with 288 fibers per subunit for a 6912-fiber cable, and the three 288-fiber subunit cable 10 with 864 fibers as shown in FIG. 1. In various embodiments of an optical fiber cable, the subunits 24 are helically stranded together to form the core and then jacketed. The subunits 24 can also be SZ stranded to enable mid span access. In still other embodiments, the subunits 24 can be disposed longitudinally within the cable jacket 12 (i.e., such that the subunits 24 are not stranded). In various exemplary embodiments, the cable jacket 12 can be composed of or include high-density polyethylene (HDPE) or medium-density polyethylene (MDPE) for embodiments of the cable 10 intended for use in outside-plant environments (e.g., outdoor aerial installation, buried installation, etc.). In various additional embodiments, the cable jacket 12 can be composed of or include PVC, any of various LSZH) materials, or any of various flame-resistant polyethylene (FRPE) compositions for embodiments of the cable 10 intended for indoor/outdoor or indoor-only environments. Using loosely-bundled subunits 24 with rollable ribbons or fibers can achieve higher densities by utilizing a greater fraction of the free space within the interior cavity of the cable jacket 12 vs. conventional ribbons or harder round subunit binders (e.g., buffer tubes).

The use of subunits 24 with an extruded subunit binder 26 offers additional functionality that facilitates installation in the field and furcation. An installer of the cable 10 can easily route the subunits 24 to different locations (e.g., for splicing to different components). The subunit binder 26 of a subunit 24 provides protection for the ribbons 22 disposed therein and thus inhibits damage to the ribbons 22 even when the subunit 24 is routed independently from the remainder of the cable 10.

In various embodiments wherein the subunits 24 are bound with a thin film subunit binder 26, the subunit binder 26 can comprise a silicone-based thermoplastic additive. It has been observed that thin film subunit binders 26 made of some materials, such as LLDPE exhibit a relatively high coefficient of friction between one another and may tend to stick to one another. This friction and sticking can cause difficulties in manufacture of the cable 10. For instance, a portion of a thin film subunit binder 26 can stick to itself on a payoff reel during stranding. This can later prevent the thin film subunit binder 26 from deforming as intended in response to stresses on the cable 10 when the cable 10 is installed in the field. Extrusion of a hot cable jacket material around the subunits 24 can increase the likelihood of the subunits 24 sticking to one another, as the extrusion temperature of the cable jacket 12 may be higher than a softening or melting temperature of the material of the thin film subunit binder 26.

The addition of a silicone-based thermoplastic additive to the material used to form the thin film subunit binder 26 has been shown to prevent sticking of the thin film subunit binders 26 to one another during manufacture of the cable 10. The addition of these additives has further been found to improve the optical performance of the cable 10 (e.g., by reducing attenuation of signals propagating in the optical fibers 20 of the cable 10 during certain operating conditions). The silicone-based thermoplastic additive can be or include high or ultra-high molecular weight poly(siloxanes) such as polydimethylsiloxane (PDMS). In exemplary embodiments, the thin film subunit binder 26 can include a silicone-based thermoplastic additive such that a final silicone content of the subunit binder 26 is a wt % relative to a total weight of the material of the thin film subunit binder 26 of 1-10 wt %, 1.5-7.5 wt %, or 2-5 wt %, inclusive. In a particular example, a silicone content of the thin film subunit binder 26 is about 1-3 wt %. In a still more particular example, a final silicone content of the subunit binder 26 is about 1.5 wt %.

As shown in FIG. 1, the cable 10 can include various additional elements. By way of example, and not limitation, the cable 10 can include strength members 30 embedded in the jacket 12, which strength members 30 can be or include glass-reinforced plastic (GRP) rods, tensile yarns (e.g., aramid yarns), stranded wires, or the like. In some embodiments, the cable 10 can include a water blocking tape 32 or yarn to surround the plurality of subunits 24 in the core 18 and provide protection against water intrusion. In various embodiments, a powder comprising water-blocking superabsorbent polymer (SAP) can be blown into an interior wall of the cable jacket 12 during extrusion of the cable jacket 12, such that particles of the SAP powder are embedded in the interior wall of the cable jacket 12. In such embodiments, the water blocking tape 32 or yarn can be omitted without sacrificing protection of the cable 10 against water penetration.

In various exemplary embodiments, the cable jacket 12 can have one or more access features 34 disposed therein. In some embodiments, the access features 34 can be or include ripcords. In other embodiments, the access features 34 comprise strips of a dissimilar polymer that is co-extruded with the cable jacket 12 such that the strips of polymer extend longitudinally along the length of the cable jacket 12. In such embodiments, the access features 34 function as discontinuities in the cable jacket 12 that lower a peel force needed to tear the cable jacket 12, thereby allowing an installer to easily access to the cable core 18 without the use of specialized tools. In some embodiments, the cable 10 can have one or more ripcords (not shown) disposed within the cable core 18 to facilitate access to the cable core 18 by an installer. While not depicted in FIG. 1, the subunits 24 can further include ripcords disposed therein to facilitate access to the ribbons 22 by an installer of the cable 10.

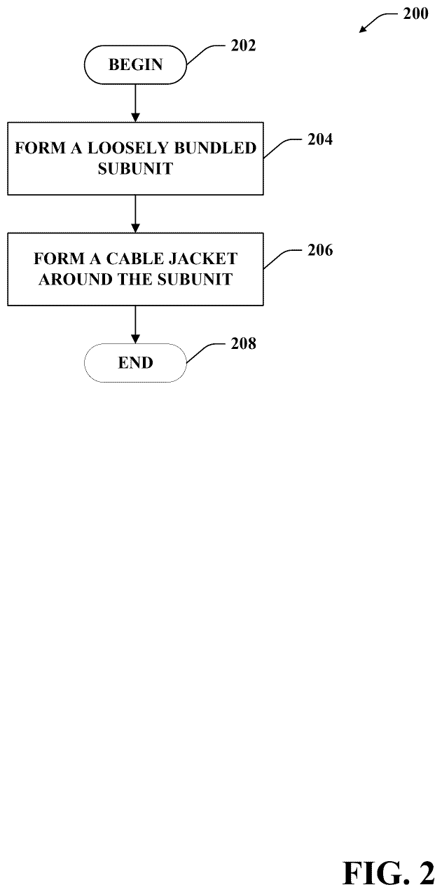

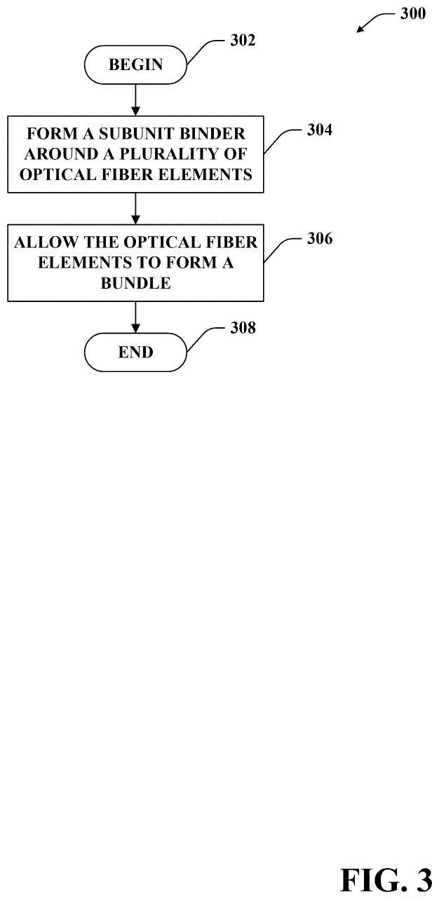

To manufacture loosely-bundled subunits 24, the subunit binder 26 of each subunit 24 is formed to have a greater diameter than a diameter of a bundle of the ribbons 22 that is disposed inside the subunit binder 26. FIGS. 2-3 illustrate exemplary methods relating to forming a high-density optical fiber cable and forming a loosely-bundled subunit. While the methods are shown and described as being a series of acts that are performed in a sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein. Still further, methods described herein can include additional acts not described or depicted herein.

Referring now to FIG. 2, a method 200 for forming a high-density optical fiber cable (e.g., the optical fiber cable 10) is illustrated. The method 200 begins at 202 and at 204 a loosely-bundled subunit is formed. The loosely-bundled subunit comprises a plurality of optical fiber elements and a subunit binder that surrounds the optical fiber elements. The loosely-bundled subunit can be one of a plurality of loosely-bundled subunits that are to be included in a same optical fiber cable. At 206, a cable jacket is formed around the subunit formed at 204 as well as any additional subunits that are to be included in the same optical fiber cable. Thus, the high-density optical fiber cable formed by the method 200 includes one or more loosely-bundled subunits disposed within an interior cavity of a cable jacket.

Referring now to FIG. 3, an exemplary method 300 for forming a loosely-bundled subunit is illustrated. The exemplary method 300 can be used, for example, to form the loosely-bundled subunit at 204 of the method 200. The method 300 begins at 302 and at 304 a subunit binder is formed around a plurality of optical fiber elements. In exemplary embodiments, the subunit binder is formed around the optical fiber elements while the group of optical fiber elements is in an expanded state. For example, and as will be described in greater detail below, the plurality of optical fiber elements can be stranded together, and the subunit binder can be formed around the optical fiber elements downstream from a stranding machine but prior to the optical fiber elements being wound down to a tight bundle. Thus, the subunit binder can be formed to have an inner diameter that is greater than an outer diameter of a bundle formed by the plurality of optical fiber elements.

In various embodiments, the subunit binder is formed around the plurality of optical fiber elements at 304 while employing an expander component to maintain a minimum inside diameter of the subunit binder. In a non-limiting example, the expander component can be an expansion tube around which the subunit binder is formed. The expansion tube can have an outside diameter that is greater than a diameter of a bundle of the optical fiber elements. Hence, the subunit binder can be formed about the expansion tube such that the inside diameter of the subunit binder is approximately equal to the outside diameter of the expansion tube (and thus greater than the diameter of the bundle of optical fiber elements).

At 306, the plurality of optical fiber elements are allowed to form a bundle. For instance, the optical fiber elements can be allowed to draw down during stranding to form a tight bundle. The tight bundle is characterized by an outer diameter that is less than the inner diameter of the subunit binder. In other words, the optical fiber elements are loosely bound by the subunit binder, thereby forming a loosely-bundled subunit. The method 300 completes at 308.

The methods for forming loosely-bundled subunits described herein may be adapted to form subunits having thin film subunit binders or thread- or yarn-based subunit binders.

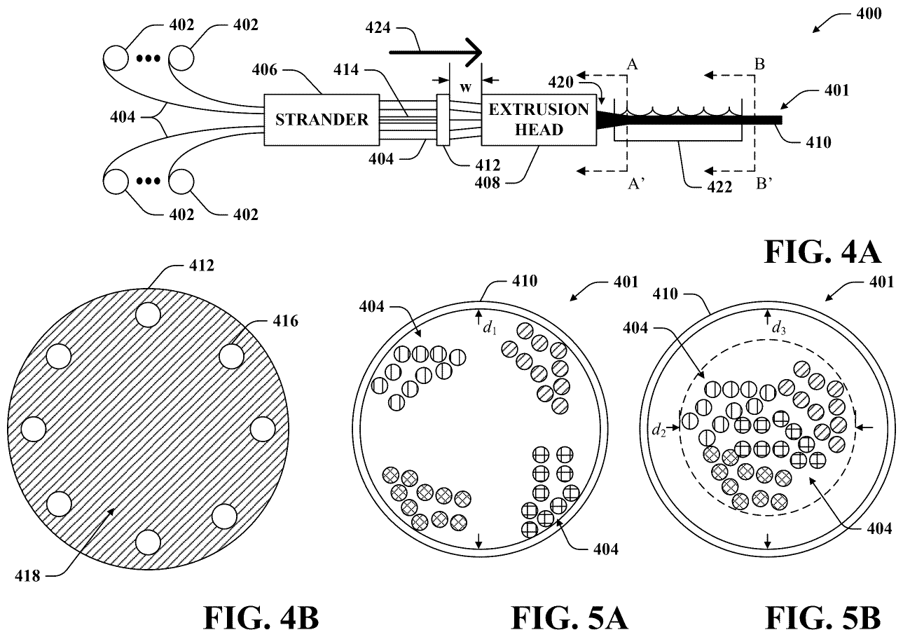

Referring now to FIG. 4A, an exemplary system 400 for forming a loosely-bundled subunit having a thin film subunit binder is illustrated. The system 400 includes a plurality of payoffs 402 that each feed a respective optical fiber element 404 to a strander 406. In various embodiments, the optical fiber elements 404 can be individual optical fibers. In other embodiments, the optical fiber elements 404 can be optical fiber ribbons, such as rollable, intermittently-bonded optical fiber ribbons. The strander 406 is configured to strand the optical fiber elements 404 into a stranded bundle. The strander 406 can be configured to strand the optical fiber elements 404 to have a helically-stranded configuration or an S-Z-stranded configuration.

The system 400 further includes an extrusion head 408 that is configured to extrude a polymeric thin film subunit binder 410 about the optical fiber elements 404. It is to be appreciated that, while not depicted in FIG. 4 for the sake of simplicity and to facilitate understanding, the extrusion head 408 may include or be coupled to various equipment that facilitates extrusion of the thin film subunit 410. For instance, the extrusion head 408 may include a heating element and may be coupled to a reservoir that feeds pellets or beads of a polymer material from which the subunit binder 410 is desirably formed to the extrusion head 408.

An extruded thin film typically draws down to the diameter of a core about which the film is extruded before the polymer extrudate cools and solidifies. Such draw down yields a tightly-bundled subunit rather than the loosely-bundled subunits described herein. The system 400 includes a lay plate 412 that is positioned between the strander 406 and the extrusion head 408. The lay plate 412 maintains a spacing of the optical fiber elements 404 until they enter the extrusion head 408 such that the optical fiber elements 404 remain in an expanded state when a cone of extrudate material contacts the optical fiber elements 404. The lay plate 412 is coupled to the strander 406 by way of a driveshaft 414 such that the lay plate 412 and the strander 406 share a common rotational axis.

Referring now to FIG. 4B, an exemplary lay plate 412 is shown, wherein the lay plate 412 comprises a substantially circular disk having a plurality of apertures 416 formed therein. The lay plate 412 further comprises a central portion 418 in which no apertures are present. The driveshaft 414 can be coupled to the central portion 418 of the lay plate 412 by any of various fasteners. Each of the optical fiber elements 404 passes through one of the apertures 416 prior to entering the extrusion head 408. The lay plate 412 thereby maintains a spacing of the optical fiber elements 404 prior to the elements 404 entering the extrusion head 408. The plurality of apertures 416 can be arranged about the lay plate 412 in any suitable arrangement according to a desired stranding pattern for the optical fiber elements 404. For instance, the apertures 416 depicted in FIG. 4B are shown in a single-layer circular arrangement, equally spaced about a center of the lay plate 412. It is to be appreciated however, that the apertures 416 can be arranged in multiple layers to facilitate multiple stranding layers of the optical fiber elements 402. Furthermore, the apertures 416 within each of one or more layers can have a non-uniform spacing about the center of the lay plate 412. A spacing of an outermost layer of the apertures 416 can be selected based upon a desired inside diameter of the subunit 410. It is further to be appreciated that the central portion 418 of the lay plate 412 can include a central aperture (not shown) in order to accommodate one or more optical fiber elements.

Referring again to FIG. 4A, as the extrudate of the thin film subunit binder 410 exits the extrusion head 408 the extrudate forms an extrusion cone 420 that draws down to a reduced diameter. The system 400 further includes a water trough 422 into which the thin film subunit binder 410 passes when exiting the extrusion head 408. The water trough 422 cools the thin film subunit binder 410, and when sufficient cooling of the binder 410 has occurred the binder 410 ceases to draw down further. It is to be understood that any of various means can be employed to cool the molten extrudate of the thin film subunit binder 410 including, but not limited to, directed air cooling, ambient air cooling, non-water liquid cooling, etc.

An extent of the draw down of the extrudate prior to the sufficient cooling having occurred depends upon various factors including a distance between the extrusion head 408 and the water trough 422, temperatures of the extrudate and the cooling water, a diameter of the bundle of the optical fiber elements 404 after exiting the extrusion head 408, etc. The bundle diameter may be variable in a direction of travel 424 of the optical elements 404 through the manufacturing line 400 due to the stranding of the optical fiber elements 404. As described above, the lay plate 412 maintains the bundle of the optical fiber elements 404 in an expanded state as the bundle passes through the extrusion head 408. The bundle of the optical fiber elements 404, in their expanded state, prevent at least some draw down of the thin film subunit binder 410.

Referring now to FIGS. 5A and 5B, cross-sections of a subunit 401 manufactured by the system 400 (i.e., a subunit that comprises the binder 410 and the plurality of optical fiber elements 404) are shown. FIG. 5A is a cross-sectional view of the subunit 401 taken along line A-A′ as shown in FIG. 4A, at a point where the extrusion cone 420 lands on the bundle of the optical fiber elements 404 (which location may be inside or outside of the water trough 422). FIG. 5B is a cross-sectional view of the subunit 401 taken along line B-B′ as shown in FIG. 4A, further along the process direction 424 of the system 400.

As shown in FIG. 5A, the bundle of the optical fiber elements 404 are characterized by a bundle diameter d₁ at line A-A′. The bundle diameter can be defined as the diameter of the smallest circle that entirely contains the entirety of the bundle of the optical fiber elements 404 (i.e., such that all of the optical fiber elements 404 lie within the circle). By contrast, as shown in FIG. 5B, the bundle of the optical fiber elements 404 are characterized by a bundle diameter d₂ at line B-B′, where the bundle of the optical fiber elements 404 has continued to tighten as the bundle moves along the process direction 424. Thus, at line A-A′, the bundle of the optical fiber elements 404 are in an expanded state.

At line A-A′, the extrudate cone 420 of the thin film subunit binder 410 lands on surfaces of the optical fiber elements 404 in an at least partially molten state. Whereas in the at least partially molten state the thin film subunit binder 410 would ordinarily continue to draw down, the expanded state of the bundle of the optical fiber elements 404 prevents further drawdown of the subunit binder 410. Subsequently, the thin film subunit binder 410 cools and ceases to draw down even after the bundle of the optical fiber elements 404 tightens and reduces in diameter. Thus, at line B-B′, as shown in FIG. 5B, the optical fiber elements 404 tighten to a bundle having a diameter d₂ that is less than d₁, but the subunit binder 410 maintains an inside diameter d₃ that is greater than d₂ (and which may be less than or equal to the diameter d₁).

Accordingly, the subunit 401 manufactured by the system 400 is “loosely bundled” in the sense that the inside diameter d₃ of the subunit binder 410 is greater than the diameter d₂ of the tightly-stranded bundle of the optical fiber elements 404. In various embodiments, the diameter of the subunit binder 410 can be at least 5% greater than the diameter of the tightly-stranded bundle of the optical fiber elements 404, at least 10% greater than the diameter of the tightly-stranded bundle of the optical fiber elements 404, at least 15% greater than the diameter of the tightly-stranded bundle of the optical fiber elements 404, or at least 20% greater than the diameter of the tightly-stranded bundle of the optical fiber elements 404. In various embodiments, the diameter of the subunit binder 410 can be no more than 35% greater than the diameter of the tightly-stranded bundle of the optical fiber elements 404.

In various exemplary embodiments, the diameter d₂ of the “tight” bundle of the optical fiber elements 404 in the subunit 401 can be defined as:

$${d}_{2} = 2 \sqrt{\frac{1.75 F + Y}{π}} \qquad Eq . 1$$

where F is a total cross-sectional area (looking down the length of the subunit 401) of all of the optical fiber elements 404, Y is a total cross-sectional area of other elements within the subunit 401 (e.g., yarns, ripcords, tapes, etc.). In Eq. 1, a minimum free space within the diameter d₂ is assumed to be 43%, where such free space is computed as:

$$Free space = \frac{A}{F + A} \qquad Eq . 2$$

In Eq. 2, A is the cross-sectional area within the diameter d₂ that is unoccupied either by the optical fiber elements 404 (associated with the area F) or other elements within the subunit 401 (associated with the area Y).

In conventional “loose tube” cable designs, optical fibers are disposed within a buffer tube that retains a fixed shape, usually circular, and that is sufficiently large that the buffer tube is not completely filled with the optical fibers. However, such buffer tube-based designs are dissimilar to the subunits 401 described herein. In particular, the subunits 401 of the system 400 are substantially thinner (e.g., less than or equal to 150-micron wall thickness) than conventional buffer tubes, and behave differently both during manufacturing and in a final cable product. For instance, conventional buffer tubes may cease to draw down during extrusion before landing on any of the elements that are disposed therein (e.g., optical fibers). Thus, while it may have been possible to manufacture conventional thick-walled buffer tubes with diameters substantially greater than a bundle of the elements contained within, it has been difficult to manufacture thin-walled subunit binders (e.g., extruded films having wall thickness of 150 microns or less, or 100 microns or less, or 50 microns or less) with diameters greater than a bundle of the elements contained within.

It will be appreciated by those of skill in the art that the system 400 may be adapted to manufacture loosely-bundled subunits in which the optical fiber elements 404 are not stranded. For example, the strander 406 may be omitted from the system 400, and the optical fiber elements 404 fed to the extrusion head 408 without being stranded. In such embodiments, the system 400 can retain the lay plate 412 to keep the optical fiber elements 404 spread sufficiently apart entering the extrusion head 408 that the molten polymer material rests on the optical fiber elements 404 and cools to have the final diameter d₃ that is greater than a tightened diameter d₂ of the optical fiber elements 404 if they had been stranded.

While the system 400 employs a lay plate to maintain a bundle of the optical fiber elements 404 in an expanded state, it is to be appreciated that the bundle of the optical fiber elements 404 can be maintained in the expanded state by other means.

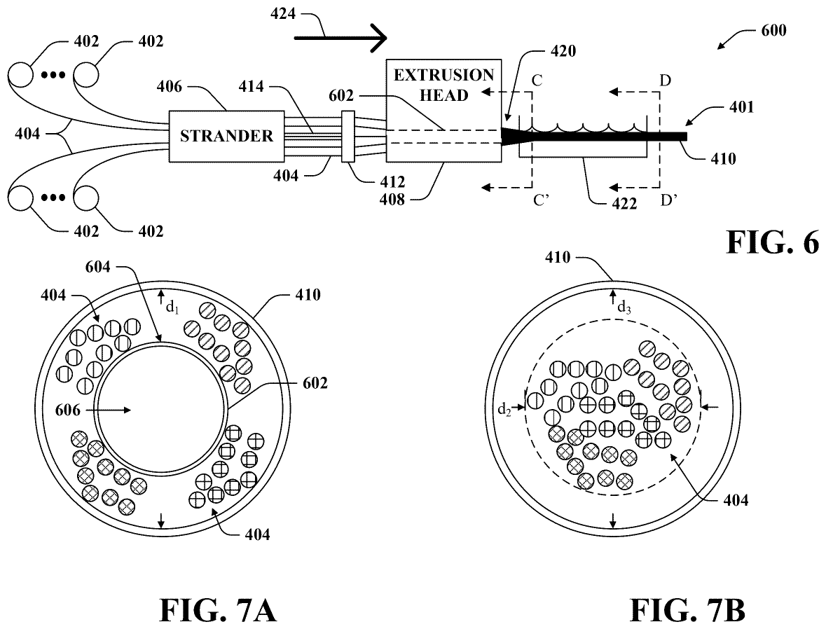

Referring now to FIG. 6, another exemplary system 600 for manufacturing loosely-bundled subunits is illustrated. The system 600 is similar to the system 400 and includes the payoffs 402 that pay off the optical fiber elements 404, the strander 406, the extrusion head 408, and the water trough 422. The system 600 can optionally include the lay plate 412 in order to facilitate entry of the optical fiber elements 404 into the extrusion head 408 with a spacing necessary to accommodate the geometry of an extrusion die.

The system 600 further includes an expansion tube 602 that extends from the extrusion head 408 and at least partially into the extrusion cone 420. In various embodiments, the expansion tube 602 can be an extension of an extrusion die that is a component of the extrusion head 408. While the expansion tube 602 is depicted in FIG. 6 as being, in various embodiments, the expansion tube 602 can be separate from and disposed entirely outside the extrusion head 408. By way of example, and not limitation, the expansion tube 602 can be positioned between the extrusion head 408 and the water trough 422 such that the extrusion cone 420 forms around the expansion tube 602.

However disposed, the expansion tube 602 is configured to maintain the thin film subunit binder 410 in an expanded state until the binder 410 has cooled sufficiently to cease drawing down. In some embodiments, the expansion tube 602 can extend into the water trough 422 to facilitate maintaining the thin film subunit binder 410 in the expanded state until the binder 410 has cooled sufficiently to cease drawing down.

In some embodiments, the expansion tube 602 is further configured to maintain the optical fiber elements 404 in an expanded state. In an example, the system 600 can be configured such that the optical fiber elements 404 are disposed around the expansion tube 602. For instance, the system 600 can include the lay plate 412 and a configuration of the lay plate 412 is such that the optical fiber elements 404 are disposed around the expansion tube 602. In other embodiments, the system 600 is configured such that the optical fiber elements 404 are disposed within the expansion tube 602 while the expansion tube 602 maintains the thin film subunit binder 610 in the expanded state. In still other embodiments, the system 600 can be configured such that some number of the optical fiber elements 404 are disposed within the expansion tube 602 whereas a remainder of the optical fiber elements 404 are disposed around an outside of the expansion tube 602.

Referring now to FIGS. 7A-7C, cross-sectional diagrams of a subunit that is formed by the system 600 and that comprises the thin film subunit binder 410 and the optical fiber elements 404 are illustrated. FIG. 7A is a cross-section taken along line C-C′ shown in FIG. 6, and depicts an embodiment in which the expansion tube 602 is configured to maintain both the subunit binder 410 and a bundle of the optical fiber elements 404 in an expanded state. As shown in FIG. 7A, the optical fiber elements 404 are disposed around and rest on an outside surface 604 of the expansion tube 602. In other words, the expansion tube 602 maintains a bundle of the optical fiber elements 404 in an expanded state by preventing the bundle of the optical fiber elements 404 from tightening down to its final, smaller diameter. The extrudate material that forms the thin film subunit binder 410 lands on the optical fiber elements 404 and is thereby kept at the expanded diameter d₁. An OD of the expansion tube 602 can be selected such that the bundle of the optical fiber elements 404 resting on the outside surface 604 of the expansion tube 602 has a diameter at least as great as an intended final ID of the thin film subunit binder 410.

The expansion tube 602 is shown in FIG. 7A as a hollow tube having an interior cavity 606. It is to be appreciated that at least some of the optical fiber elements 404 can be disposed within the interior cavity 606 of the expansion tube 602. However, it is to be appreciated that in embodiments wherein the optical fiber elements 604 are disposed entirely around the outside surface 604 of the expansion tube 602, the expansion tube 602 can instead be substantially solid (i.e., not hollow).

As the thin film subunit binder 410 advances in the process direction 424, the thin film subunit binder 410 (and in some embodiments, the optical fiber elements 404) moves off of the expansion tube 602. In other words, the thin film subunit 410 and the optical fiber elements 404 advance past an end of the expansion tube 602 (not shown). Referring now to FIG. 7B, a cross-section taken along line D-D′ in FIG. 6 is shown, wherein the line D-D′ is positioned beyond the end of the expansion tube 602. Hence, in FIG. 7B, the thin film subunit binder 410 (and in some embodiments, the optical fiber elements 404) have fallen off the expansion tube 602. After passing off of the expansion tube 602, the thin film subunit binder 410 retains an inner diameter d₃ that is greater than the diameter d₂ of the fully-stranded bundle of the optical fiber elements 404.

It is to be appreciated that the thin film subunit binder 410 is flexible, and may be capable of bending, folding upon itself, or deforming in response to external forces. Unlike conventional buffer tubes, for example, the thin film subunit binder 410 need not be disposed along a circle having the diameter d₃, and is instead free to deform to substantially any contiguous shape (e.g., to partially conform to a shape of the optical fiber elements 404).

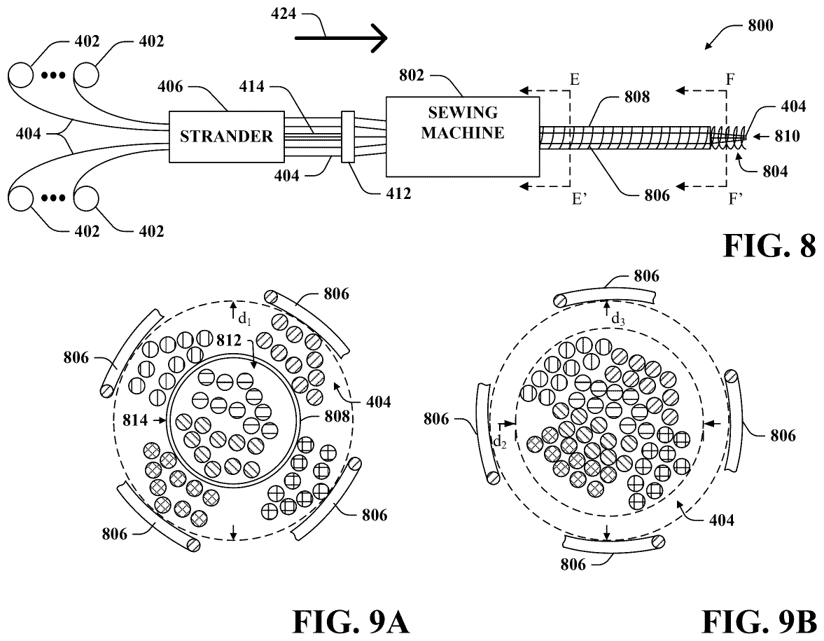

Referring now to FIG. 8, another exemplary system 800 for forming loosely bundled subunits is illustrated. The system 800 comprises payoffs 402 that pay off optical fiber elements 404, and strander 406. The system 800 can further optionally include a lay plate 412 that is driven by a driveshaft 414 that is coupled to the strander 406 such that the lay plate 412 maintains a spacing of the optical fiber elements 404 exiting the strander 406.

The system 800 is configured to loosely bundle subunits using stitched thread rather than an extruded film. Accordingly, the system 800 includes a sewing machine 802 that is configured to sew a stitch 804 around a bundle of the optical fiber elements 404, the stitch 804 being formed of a thread 806. The thread 806 can be or include any of various types of threads such as, but not limited to, a polyester thread of between 18 and 24 tex, inclusive. In some embodiments, the thread 806 can have a water blocking material (e.g., a water-swellable powder) applied thereto. The sewing machine 802 can be configured to sew any of various kinds of stitches around the bundle of the optical fiber elements 404 that are capable of binding the bundle of the optical fiber elements 404 together. For example, the sewing machine can be configured to sew a serger, or overlock stitch around the bundle of the optical fiber elements 404. It is to be appreciated that the thread 806 is not wound about the optical fiber elements 404 (e.g., in a helical winding pattern), but rather is sewn to form the stitch 804 that loosely binds the optical fiber elements 404.

The system 800 further includes an expansion tube 808. The expansion tube 808 is positioned such that the sewing machine 802 sews the stitch 804 around the expansion tube 808. Thus, a final minimum diameter of the stitch 804 can be controlled based upon selection of an outside diameter of the expansion tube 808. It is to be understood that, as used herein, the diameter of the stitch 804 is defined as the diameter of a smallest circle about which the stitch 804 can be disposed in a taut state. A size of the stitch 804 can be equivalently stated in terms of a circumference, wherein the circumference of the stitch 804 is defined as the circumference of the smallest circle about which the stitch 804 can be disposed in the taut state. Collectively, the stitch 804 formed of the thread 806 and the optical fiber elements 404 disposed therein constitute a loosely bundled subunit 810.

Similarly to the expansion tube 602, the expansion tube 808 can be substantially solid or can be hollow (i.e., having an interior cavity disposed therein). Hence, in some embodiments, the lay plate 412 is configured to maintain one or more of the optical fiber elements 404 on an outside surface of the expansion tube 808. In some embodiments, the lay plate 412 is configured to guide one or more of the optical fiber elements 404 into an interior cavity of the expansion tube 808.

Referring now to FIG. 9A, a cross-sectional view of the system 800 taken along line E-E′ shown in FIG. 8 is illustrated. In embodiments of the system 800 depicted partially in FIG. 9A, the expansion tube 808 includes an interior cavity 812. In this embodiment, some number of the optical fiber elements 404 are disposed around an outside surface 814 of the expansion tube 808, whereas other of the optical fiber elements 404 are disposed within the interior cavity 812 of the expansion tube 808. However, it is to be appreciated that in other embodiments, the optical fiber elements 404 can be exclusively disposed within the interior cavity 812 of the tube 808, or exclusively disposed around the outside surface 814 of the tube 808.

As shown in FIG. 9A, the thread(s) 806 of the stitch 804 are formed around and rest on the optical fiber elements 404 that are disposed around the outside surface 814 of the expansion tube 808. In other words, the stitch 804 is formed and maintained in an expanded state characterized by a first diameter d₁. In embodiments of the system 800 depicted partially in FIG. 9A, the expanded-state diameter d₁ is a function of the outside diameter of the expansion tube 808 and a size of the optical fiber elements 404 disposed around the tube 808. In embodiments wherein the optical fiber elements 404 are disposed exclusively within the interior cavity 812 of the tube 808, the expanded-state diameter d₁ can be approximately equal to the outside diameter of the expansion tube 808.

After the sewing machine 802 sews the stitch 804 around the expansion tube 808, the stitch 804 is allowed to “fall off” an end of the expansion tube 808, along with any of the optical fiber elements 404 that were disposed around the outside surface 814 of the tube 808. Thereafter, the optical fiber elements 404 draw down to their fully stranded state imparted by the strander 406. As the optical fiber elements 404 draw down, the stitch 804 remains in an at least partially expanded state. Referring now to FIG. 9B, a cross-sectional view of the system 800 taken along line F-F′ is shown. In the view depicted in FIG. 9B, the optical fiber elements 404 are drawn down to a tightly stranded state characterized by a diameter d₂. By contrast, the stitch 804 formed by the threads 806 remains in an at least partially expanded state characterized by a diameter d₃. The diameter d₃ is greater than the diameter d₂ of the tightly-stranded bunder of the optical fiber elements 404. Additionally, the diameter d₃ may be less than or equal to the expanded-state diameter d₁ of the stitch 804 when the stitch 804 was formed around the expansion tube 808.

It is to be appreciated that after the loosely-bundled subunit 810 is formed, the threads 806 of the stitch 804 are partially unconstrained in that the stitch 804 is not always disposed along the diameter d₃ as shown in FIG. 9B. For instance, all or a portion of the stitch 804 may rest on one or more of the optical fiber elements 804, even when the optical fiber elements 804 are tightly stranded to the diameter d₂. However, the loose stitch 804 is not taut and does not substantially resist deformation until the stitch 804 is expanded to the diameter d₃.

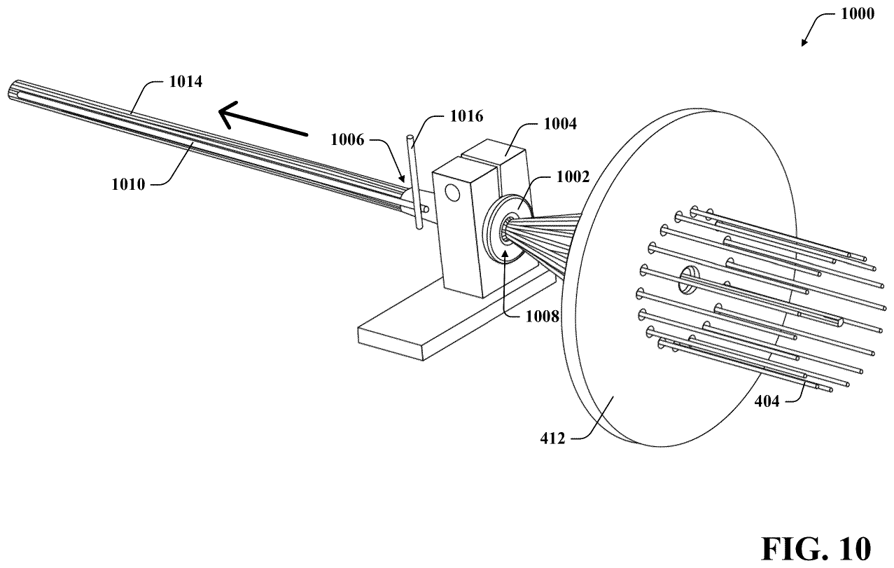

Other variations of the systems 400, 600, 800 described above are contemplated as being within the scope of the present disclosure. For example, and referring now to FIG. 10, an exemplary guide system 1000 is illustrated, wherein the guide system 1000 may partially replace certain components of the system 800 in connection with forming a loosely-bound subunit having a loosely-stitched binder thread. The guide system 1000 includes the lay plate 412 by way of which a plurality of optical fiber elements 404 are guided during a stranding process. The guide system 1000 further includes a guide tube 1002, which tube 1002 is held in place by a mounting structure 1004. In various embodiments, the mounting structure 1004 may be or include a clamp that is itself mounted to another stable base structure. The guide tube 1002 receives the plurality of optical fiber elements 404 from the lay plate 412 and guides the elements 404 toward an outlet 1006 of the guide tube 1002, at which outlet 1006 the optical fiber elements 404 are in a tightly-stranded state. The guide tube 1002 can further comprise a flared inlet 1008 that facilitates entry of the optical fiber elements 404 into the guide tube 1002.

The guide system 1000 further includes an expansion rod 1010 that extends along a process travel direction 1012 of the optical fiber elements 404 and substantially parallel to the bundle 1014 of the optical fiber elements 404. A sewing machine (e.g., sewing machine 802), represented in FIG. 10 by sewing needle 1016, can sew a stitch (not shown) around both the bundle 1014 of the optical fiber elements 404 and the expansion rod 1010. The expansion rod 1010 effectively increases the diameter of the stitch formed by the sewing machine, thereby yielding a loosely-bundled subunit similar to the subunit 810. It is to be appreciated that the guide system 1000 can be used to replace the expansion tube 808 of the system 800.

It is to be understood that in any of the various systems 400, 600, 800 above, additional elements apart from optical fiber elements 404 can be included inside a loosely bundled subunit. By way of example, and not limitation, a water blocking tape or thread can be stranded or longitudinally passed with a bundle of optical fiber elements 404 such that the water blocking tape or thread is disposed inside a loosely bundled subunit with the optical fiber elements 404.

What has been described above includes examples of one or more embodiments. It is, of course, not possible to describe every conceivable modification or alteration of the above systems, devices, or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An optical fiber cable comprising:
a cable jacket having an interior cavity;
a plurality of subunits disposed within the interior cavity, wherein each of the subunits comprises:
a plurality of optical fiber elements; and
a subunit binder that surrounds the plurality of optical fiber elements, the subunit binder comprising one of:
a polymeric film having an average thickness of less than or equal to 150 microns; or
a thread that is sewn around the plurality of optical fiber elements;
wherein the subunit binder is characterized by a first diameter, wherein a bundle of the plurality of optical fiber elements is characterized by a second diameter, the first diameter being at least 5% larger than the second diameter.

2. The optical fiber cable of claim 1, wherein the optical fiber elements are optical fibers.

3. The optical fiber cable of claim 1, wherein the optical fiber elements are optical fiber ribbons, each of the optical fiber ribbons comprising a plurality of optical fibers.

4. The optical fiber cable of claim 1, the first diameter being at least 10% larger than the second diameter.

5. The optical fiber cable of claim 1, wherein the subunit binder comprises the polymeric film.

6. The optical fiber cable of claim 5, wherein the polymeric film comprises a siloxane-based additive such that a silicone content of the polymeric film is 1-10 wt % of a total weight of the polymeric film.

7. A method comprising:
forming a subunit that comprises:
a plurality of optical fiber elements; and
a subunit binder that surrounds the plurality of optical fiber elements;
wherein forming the subunit comprises:
forming the subunit binder around the plurality of optical fiber elements while the optical fiber elements are in an expanded state characterized by a first diameter; and
allowing the optical fiber elements to form a bundle characterized by a second diameter, wherein the first diameter is at least 5% larger than the second diameter.

8. The method of claim 7, wherein forming the subunit binder around the plurality of optical fiber elements comprises extruding a polymeric film around the plurality of optical fiber elements, wherein the polymeric film cools to have an inner diameter approximately equal to the first diameter.

9. The method of claim 8, wherein the polymeric film has an average thickness of less than or equal to 150 microns.

10. The method of claim 8, wherein the polymeric film comprises a siloxane-based additive.

11. The method of claim 10, wherein the siloxane-based additive is present in the polymeric film at a concentration of between 1 wt % and 10 wt % of a weight of the polymeric film.

12. The method of claim 10, wherein the siloxane-based additive comprises polydimethylsiloxane (PDMS).

13. The method of claim 8, wherein the polymeric film comprises at least one of low-density polyethylene (LDPE) or linear low-density polyethylene (LLDPE).

14. The method of claim 7, wherein forming the subunit binder around the plurality of optical fiber elements comprises sewing a thread about the plurality of optical fiber elements.

15. The method of claim 14, further comprising maintaining the optical fiber elements in the expanded state while sewing the thread about the plurality of optical fiber elements.

16. The method of claim 15, wherein maintaining the optical fiber elements in the expanded state comprises passing the optical fiber elements over a tube having an outer diameter greater than or equal to the first diameter.

17. The method of claim 14, wherein the thread comprises a water-blocking material.

18. The method of claim 7, wherein the plurality of optical fiber elements are loose optical fibers.

19. The method of claim 7, wherein the optical fiber elements are intermittently-bonded optical fiber ribbons.

20. A method for forming a subunit of an optical fiber cable, the method comprising:
stranding a plurality of optical fiber elements together to form a bundle having a first diameter;
sewing a thread about the bundle to form a stitch that surrounds the bundle, the thread sewn such that the stitch has a second diameter that is at least 5% greater than the first diameter.
